(19) United States
(12) Patent Application Publication
(10) Pub. No.: US 2023/0328091 A1
(43) Pub. Date: Oct. 12, 2023

(54) AUTOMATED DISCOVERY OF VULNERABLE ENDPOINTS IN AN APPLICATION SERVER

(71) Applicant: VMware, Inc., Palo Alto, CA (US)

(72) Inventor: Dimitar PROYNOV, Sofia (BG)

(21) Appl. No.: 17/658,380

(22) Filed: Apr. 7, 2022

(51) Int. Cl. H04L 9/40

(52) U.S. Cl. CPC H04L 63/1433; H04L 63/20

(57) ABSTRACT

The disclosure provides an approach for discovering vulnerable application server endpoints. Embodiments include retrieving, from an application server, an object representing a front controller of the application server. Embodiments include extracting, from the object, values for a plurality of variables. Embodiments include constructing, based on the values for the plurality of variables, one or more universal resource locators (URLs) corresponding to one or more methods of the front controller. Embodiments include sending one or more unauthenticated requests to one or more resources indicated by the one or more URLs. Embodiments include determining, based on a given response to a given unauthenticated request of the one or more unauthenticated requests, whether a given URL of the one or more URLs is vulnerable. Embodiments include performing one or more actions based on the determining of whether the given URL is vulnerable.

### BACKGROUND

An application server (e.g., which may be a physical or virtual machine) may host (execute) a plurality of applications, such as web applications. In some cases, an application server may be extensible, allowing functionality to be added from within an organization that provides or manages the application server and/or from outside the organization. For example, plugins may be installed on the application server in order to add various types of functionality. A plugin can provide a user interface (UI) component and/or a server-side component. The server-side component acts as an intermediary between the plugin's UI and any backend services (e.g., running on the application server) that the plugin uses.

An organization that provides or manages an extensible application server may not have control over the quality and/or security of applications, such as plugins, that are added to the server. In some cases, the number of applications on an extensible application server can grow so large that ensuring the security of these applications can become prohibitively difficult.

Accordingly, there is a need in the art for improved techniques for ensuring security of an extensible application server.

### BRIEF DESCRIPTION OF THE DRAWINGS

FIG. 1 is an illustration of example computing components related to automated discovery of vulnerable application server endpoints.

FIG. 2 illustrates an example of constructing URLs for automated discovery vulnerable application server endpoints.

FIG. 3 illustrates an example of automated discovery of vulnerable application server endpoints.

FIG. 4 depicts example operations related to automated discovery of vulnerable application server endpoints.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure provides an approach for automated discovery of vulnerable endpoints (e.g., applications) on an application server, particularly for extensible application servers For example, an extensible application server may allow applications such as plugins to be installed (e.g., by entities within an organization that provides or manages the application server and/or by entities outside the organization) in order to add additional functionality to the application server.

A plugin installed on an extensible application server generally includes a front controller, which is a software component that acts as a centralized request handling mechanism such that all requests directed to the plugin will be initially processed by a single handler and then dispatched to other handlers as appropriate. A handler generally refers to a software component that receives and processes data that is sent in a request that is directed to a particular service or method, which may be indicated by a universal resource locator (URL). For example, a front controller of a plugin may receive a request directed to a particular URL, and may dispatch the request to a handler associated with the method corresponding to the particular URL.

Authentication of requests generally involves verifying that an entity (e.g., device, application, user, and/or the like) sending the request is authorized to access a resource (e.g., URL), such as based on authentication rules that indicate which entities are granted access. It is noted that while certain embodiments are described herein with respect to resources associated with URLs, techniques described herein may be applicable to other types of resources as well. Industry practice for non-extensible application servers (e.g., that include a single application) is to refuse all unauthenticated requests to access URL endpoints (e.g., resources indicated by URLs), apart from limited exceptions such as allowing unauthenticated access to a login URL. However, plugins added to an extensible application server are separate applications with separate security logic that may be outside of the control of an organization that provides or manages the application server. For example, a master security configuration of an application server may not apply to plugins added to the application server. In some cases, a plugin may allow unauthenticated access to one or more URLs, which may provide a malicious actor with the ability to extract information and/or completely take over a vulnerable system. This may particularly be the case if operations such as upload are allowed by the plugin without authentication (e.g., thereby allowing an attacker to upload malicious code to the application server).

As the complexity of an extensible application server grows (e.g., due to ongoing addition of functionality), software developers of various skill levels can contribute to the extensible application server and potentially leave a plugin without a sufficiently strict security configuration, thus enabling unauthenticated access to URL endpoints provided by the plugin being developed. In such circumstances, timely identification of the issue is important in order to reduce the cost of fixing it, ideally prior to release of the software to the general public.

Embodiments of the present disclosure involve automated discovery of vulnerable endpoints in an application server (e.g., resources on the application server that are exposed by URLs that can be accessed without authentication) through the use of a vulnerability detection component on the application server. The vulnerability detection component is generally a software component that obtains information from plugins on the application server in order to determine all URLs exposed by the plugins, and then tests the URLs for vulnerabilities. In certain embodiments, the vulnerability detection component obtains an object from each plugin representing the front controller of the plugin (e.g., the front controller may be represented by a class in an object oriented programming language), such as using reflection, and extracts components of URLs (e.g., names of directories and/or files) from the object. Reflection is an operation provided in the Java® programming language that allows an application to inspect and manipulate classes, interfaces, constructors, methods, and fields at run time, and other programming languages may provide similar functionality. Once an object representing a front controller is obtained (e.g., using reflection), values for the variables needed to construct URLs exposed by the front controller can be obtained from the object and used to construct the URLs.

In some embodiments, the vulnerability detection component tests the URLs by sending unauthenticated requests, such as hypertext transfer protocol (HTTP) requests that do not include applicable authentication credentials, to the URLs and determining whether responses received to the unauthenticated requests are acceptable. An acceptable response to an unauthenticated request is generally a response of “unauthenticated” (e.g., HTTP code 401) or “forbidden” (e.g., HTTP code 403). If an unacceptable response (e.g., an HTTP code other than 401 or 403) is received to an unauthenticated request to a URL, the vulnerability detection component may determine that the URL is vulnerable. The vulnerability detection component may take action upon determining that a URL is vulnerable, such as generating a notification (e.g., a log entry indicating the vulnerability) and/or, in some cases, crashing the application server to protect against potential attacks until the vulnerability is addressed.

Accordingly, embodiments of the present disclosure constitute an improvement over existing techniques for securing application servers by allowing for automated discovery of vulnerabilities across multiple applications on an extensible application server. Techniques described herein thereby avoid shortcomings of existing techniques, in which security of applications on an extensible web server is left to the developers of the individual applications and/or is manually audited. By efficiently identifying URLs exposed by applications and testing the URLs for vulnerabilities in an automated fashion, techniques described herein allow vulnerabilities to be discovered and addressed promptly, thereby preventing potential attacks while allowing functionality provided by application servers to grow in a secure and trusted manner.

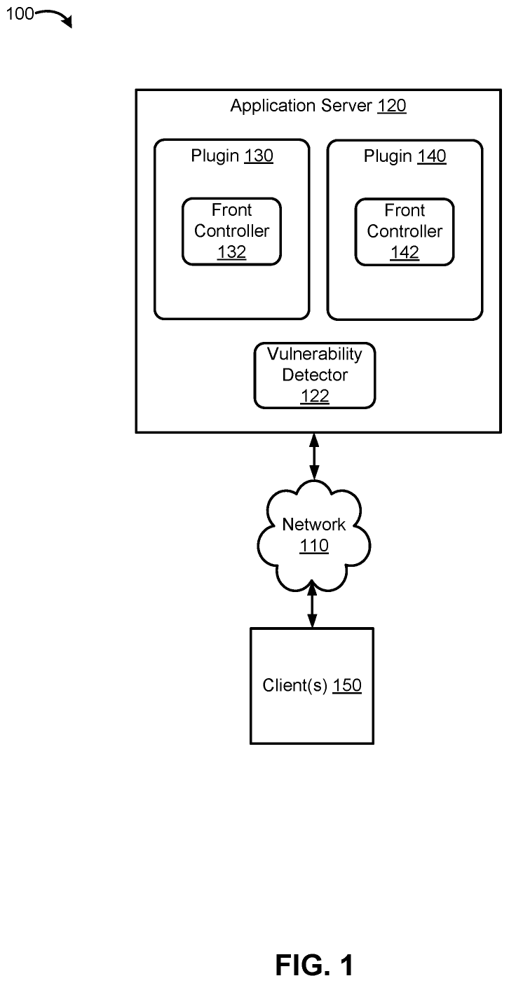

FIG. 1 is an illustration 100 of example computing components related to automated discovery of vulnerable application server endpoints.

An application server 120 and one or more clients 150 are connected to network 110. Network 110 is generally representative of a network of machines such as a local area network (“LAN”) or a wide area network (“WAN”), a network of networks, such as the Internet, or any connection over which data may be transmitted. Application server 120 and the one or more clients 150 may each comprise computing hardware such as one or more processors such as central processing units (CPUs), one or more network interface controllers (NICs), memory, and/or the like.

Application server 120 generally represents an extensible system for running applications, such as web applications, such as including common underlying services that can be utilized by the various applications running on application server 120. Application server 120 is extensible in that its functionality can be enhanced by installing additional applications, such as plugins, without updating the whole system to a new version. In some embodiments, application server 120 is a software component that runs on one or more physical computing devices, such as host computers. In some embodiments, application server 120 is a virtual computing instance (VCI) such as a virtual machine (VM). An extensible user interface (UI) component corresponding to application server 120 generally runs on user devices, such as a web browser (e.g., on a client 150), and provides extension points for UI components of plugins installed on application server 120.

Application server 120 comprises two plugins 130 and 140. A plugin is a software component that is installed independently of core functionality in an extensible system. A plugin usually does not provide functionality on its own without integration into the extensible system (e.g., relying on underlying services provided by the extensible system such as network functionality, display functionality, input device processing, file transfer functionality, and/or the like). A plugin generally has two major parts: a plugin user interface (UI); and a plugin server-side component. The plugin UI is the piece of the plugin running on a user device, such as in a web browser on a client 150, and integrates into extension points provided by a UI component of application server 120 (e.g., by calling methods provided by the UI component). The plugin server-side component runs on application server 120 and serves the plugin UI as a resource, running its own HTTP handlers and front controller and executing the plugin's backend/middle tier logic.

Plugin 130 comprises a front controller 132 and plugin 140 comprises a front controller 142. Front controllers 132 and 142 are types of HTTP handlers that handle all requests to plugins 130 and 140, respectively, delegating requests to appropriate controllers for specific methods. A front controller is a useful structure that allows web application developers to achieve flexibility, easier testing, and reuse without code redundancy. While not shown in illustration 100, plugins 130 and 140 may also include additional controllers for particular methods. A controller generally controls aspects of application logic, such as by executing methods in order to perform operations indicated in requests. An HTTP handler generally refers to a server component that implements an HTTP request-response paradigm.

For example, a user may interact with plugin 130 or 140 via a plugin UI within a UI component on a client 150, and HTTP requests may be sent from the client 150 to application server 120 (e.g., based on the user interactions). A corresponding front controller of plugin 130 or 140 handles the HTTP requests, delegating the requests to controllers for specific methods as appropriate, and responds to the requests based on executing application logic. In some cases, a plugin may expose a URL that is vulnerable to attack by allowing unauthenticated requests to be executed on applications server 120.

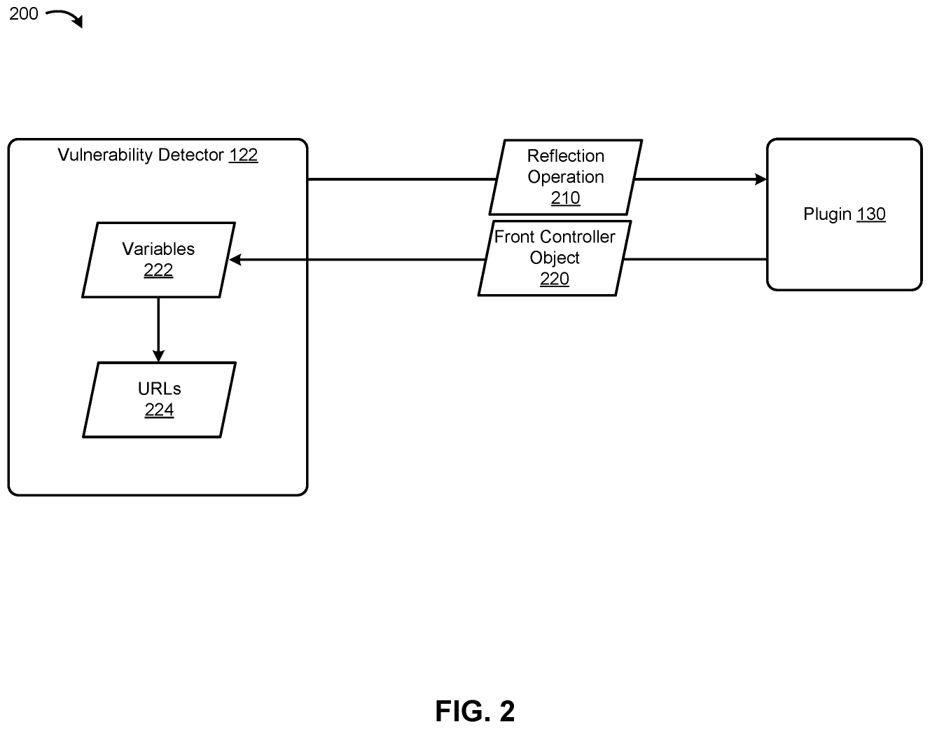

Application server 120 further comprises vulnerability detector 122, which performs operations related to discovering vulnerable application server endpoints. As described in more detail below with respect to FIG. 2, vulnerability detector 122 obtains objects representing front controllers 132 and 142 (e.g., using reflection) from plugins 130 and 140, extracts values for variables from the objects, and uses the values to construct URLs that are exposed by plugins 130 and 140.

An example of a URL exposed by a plugin is:
<http(s)>://localhost<port>/<rootPath>/<pluginContextPath>/<HttpHandlerUrlMapping>/<controllerPath>/<methodPath>

The example URL above will be explained in more detail below with respect to FIG. 2, and values for the variables making up this URL can be obtained from the object representing the front controller of the plugin.

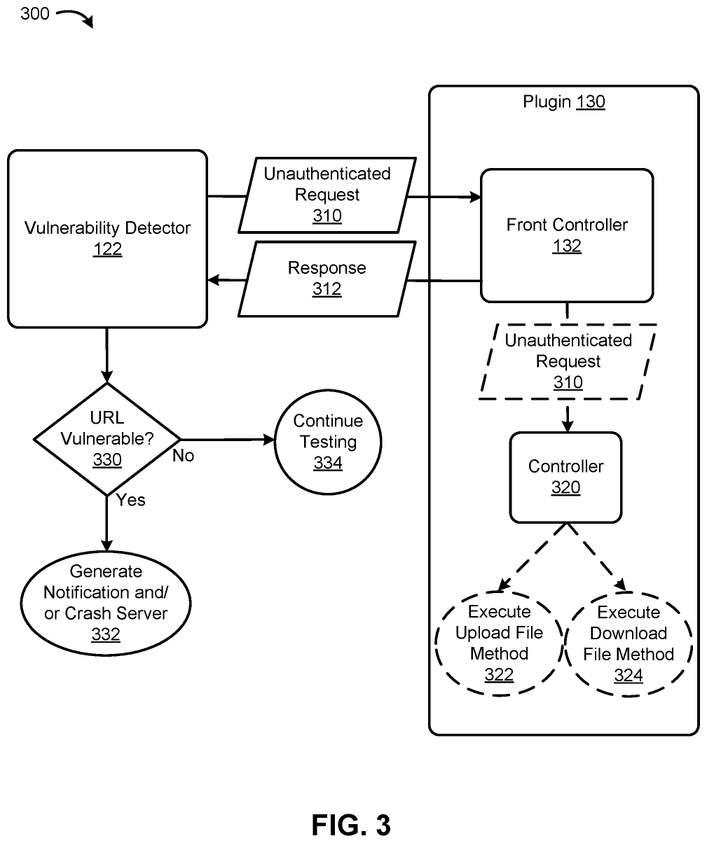

Once vulnerability detector 122 constructs the URLs exposed by plugins 130 and 140, vulnerability detector 122 tests the URLs. For example, as described in more detail below with respect to FIG. 3, vulnerability detector 122 may send unauthenticated requests to the URLs and determine whether responses to the requests indicate vulnerability. For example, if a plugin responds to an unauthenticated request to a particular URL with a response other than an unauthenticated or forbidden response, then vulnerability detector 122 may determine that the URL is vulnerable to attack. In some cases, vulnerability detector 122 performs remedial action upon determining that a URL is vulnerable to attack, such as generating a notification and/or crashing application server 120.

Client(s) 150 generally represent computing devices by which users access applications running on applications server 120, such as using a UI component (e.g., web browser) corresponding to application server 120, as described above.

FIG. 2 is an illustration 200 of an example of constructing URLs for automated discovery of vulnerable application server endpoints. Illustration 200 vulnerability detector 122 and plugin 130 of FIG. 1.

Vulnerability detector 122 uses a reflection operation 210 to request a front controller object 220 from plugin 130. For example, the front controller of plugin 130 may be implemented as an object such as a class in an object-oriented programming language, and values for variables of the class may be initialized as part of a startup process of plugin 130. Upon receiving the reflection operation 210, plugin 130 returns front controller object 220, which may include the contents of the object (e.g., class), such as including values of all variables of the object that have been assigned values (e.g., during the startup process of plugin 130).

The vendor of the application server (e.g., application server 120 of FIG. 1) has control over the lifecycle of the application server, such as initialization procedures. According to embodiments of the present disclosure, there are predefined lifecycle states that present a moment in time (e.g., just after a plugin is deployed in the application server) where all HTTP handlers and/or controller instances (e.g., including front controller instances) are available as references to objects along with their URL mappings (e.g., the URLs at which the HTTP handlers and/or controllers are configured to respond) as well as the context path of a plugin.

Vulnerability detector 122 determines values for variables 222 based on front controller object 220 in order to construct URLs 224. For example, values for variables 222 may include <rootPath>, <pluginContextPath>, and <HttpHandlerUrlMapping>, among others. In the common industry implementation of a front controller, details like a <controllerPath> and <methodPath> are generally hidden in private in-memory data structures. Thus, reflection is used to obtain an instance of the front controller object in order to reveal its private internal structure, containing the mappings of URLs to controller methods, along with parameters and supported HTTP methods (aka GET, POST, HEAD, and the like). The <rootPath>, <port> and <http(s)> to which the application server responds are configuration parameters and can be easily obtained from the application server. The <HttpHandlerUrlMapping> is the path to the front controller. Construction of the URLs 224 to each HTTP Handler and/or controller endpoint that a plugin's server component has exposed to the network is possible by concatenating the different parts of the URL (e.g., including the values for the variables mentioned above) into exact URLs.

One example of a URL (with abstract names of variables) is:
<http(s)>://localhost<port>/<rootPath>/<pluginContextPath>/<HttpHandlerUrlMapping>/<controllerPath>/<methodPath>.

An example of the above URL with the variables populated with particular values is: “http://localhost:5090/ui/vropspluginui/rest/services/uploadova”. This example URL includes the following components:
<http(s)> (populated with the example value of “http”) is a configuration parameter.

The component “localhost” is a fixed part of all URLs.

<port> (populated with the example value of “5090”) is a configuration parameter.

<rootPath> (populated with the example value of “uif”) is a configuration parameter.

<pluginContextPath> (populated with the example value of “vropspluginui/” is a plugin parameter, and is accessible in the application server's lifecycle listeners. A lifecycle listener is a software component that is configured to perform certain actions when a particular lifecycle event occurs on the application server, such as the installation or initiation of a plugin.

<HttpHandlerUrlMapping> (populated with the example value of “rest/”) is the path to the front controller, and is accessible in the application server's lifecycle listeners.

<controllerPath> (populated with the example value of “services/”) is the path to a particular controller, and is obtained via reflection (e.g., front controller object 220).

<methodPath> (populated with the example value of “uploadova”) is the path to a particular method, and is obtained via reflection (e.g., front controller object 220).

Thus, in the example above, <controllerpath> and <methodpath> represent values for variables 222 that are obtained from front controller object 220 via reflection operation 210, while values for other variables 222 may obtained from the application server's lifecycle listeners and/or are configuration parameters of the application server that are readily obtained. The variables and values described herein are included as examples, and other variables and values are possible. In certain embodiments, a URL further includes values for variables indicating parameters related to methods, such as <optionalPathParameters> and <optionalQueryParameters>, which may also be obtained via reflection (e.g., front controller object 220).

In some embodiments, such as in the case of Java® servlet, a method “contextInitialized( )” of a “javax.servlet.ServletContextListener” may be used as a lifecycle hook, and its parameter of type ServletContextEvent provides access to the ServletContext object, from which <contextPath> can be obtained as well as all ServletRegistrations, which contain the <servletPath>. In such embodiments, reflection may be used on the implementations of ServletContext to gain access to any DispatcherServlet instances, as well as to gain access to <controllerPath> and <methodPath>.

Once all URLs 224 exposed by plugin 130 (and, in some embodiments, other plugins on the application server) are constructed, vulnerability detector 122 tests the URLs 224, as described in more detail below with respect to FIG. 3.

FIG. 3 is an illustration 300 of an example of automated discovery of vulnerable application server endpoints. Illustration 300 includes vulnerability detector 122, plugin 130, and front controller 132 of FIG. 1.

Vulnerability detector 122 sends an unauthenticated request 310, addressed to a given URL (e.g., one of URLs 224 of FIG. 2), to plugin 130 in order to test the given URL. In some embodiments, vulnerability detector 122 uses separate threads to test each URL so as to test the URLs more efficiently and/or not to slow down the server deployment process. In an embodiment, vulnerability detector 122 uses an HTTP client library to issue unauthenticated request 310, which may be a request that does not include applicable authentication credentials, such as containing no session cookie, security header, and/or the like.

Unauthenticated request 310 is received by front controller 132 (which handles all requests received by plugin 130). Front controller 132 may respond to unauthenticated request 310 with an “unauthenticated” or “forbidden” response or may, in some embodiments, forward unauthenticated request 310 to a specific controller 320 (e.g., based on a controller path indicated in the URL). In such cases, controller 320 may respond to unauthenticated request 310 with an “unauthenticated” or “forbidden” response, or may execute a method indicated in unauthenticated request 310, such as an upload file or download file method. For example, controller 320 may execute an upload file method at step 322 or execute a download file method at step 324 as applicable.

Plugin 130 returns a response 312 to vulnerability detector 122, either directly from front controller 132 or from controller 320. Response 312 may include an HTTP code that indicates a result of processing unauthenticated request 310. Examples of HTTP codes include informational responses (100-199), successful responses (200-299), redirection messages (300-399), client error responses (400-499), and server error responses (500-599). An acceptable response to an unauthenticated request would be a client error response, such as “unauthenticated” (e.g., HTTP code 401) or “forbidden” (e.g., HTTP code 403).

Vulnerability detector 122 determines whether the URL is vulnerable at step 330 based on response 312. For example, vulnerability detector 122 may compare an HTTP response code in response 312 to one or more acceptable responses (e.g., code 401 or 403) to determine whether response 312 is acceptable. If vulnerability detector 122 determines that the URL is not vulnerable (e.g., if response 312 is acceptable), then testing continues at step 334, such as by testing another URL or otherwise taking no further action. Otherwise, if vulnerability detector 122 determines that the URL is vulnerable (e.g., if response 312 is unacceptable), then vulnerability detector 122 takes action at step 334 to address the vulnerability, such as generating a notification and/or crashing the application server. Generating a notification may comprise, in some embodiments, writing an entry to a log file identifying the URL as a potential security risk and/or including details of the unacceptable response to the unauthenticated request. In some embodiments, vulnerability detector 122 crashes the application server by issuing a “System.exit( )” command (e.g., in Java®), or another similar command.

The action taken by vulnerability detector 122 upon detecting a vulnerable URL may vary based on when testing is performed. For example, if the testing is performed during a development-related stage, such as a build during a development or testing stage, then vulnerability detector 122 may generate a notification and crash the application server. However, if testing is performed in a during a production stage, such as a build during a release or official stage, then a notification may be generated while leaving the application server online. For example, the application server may not be crashed during a production stage to avoid disruptions in service while the vulnerability is being addressed.

Action may be taken based on a notification to address a vulnerability, such as removing a plugin from the application server or modifying code of a plugin to prevent unauthenticated access.

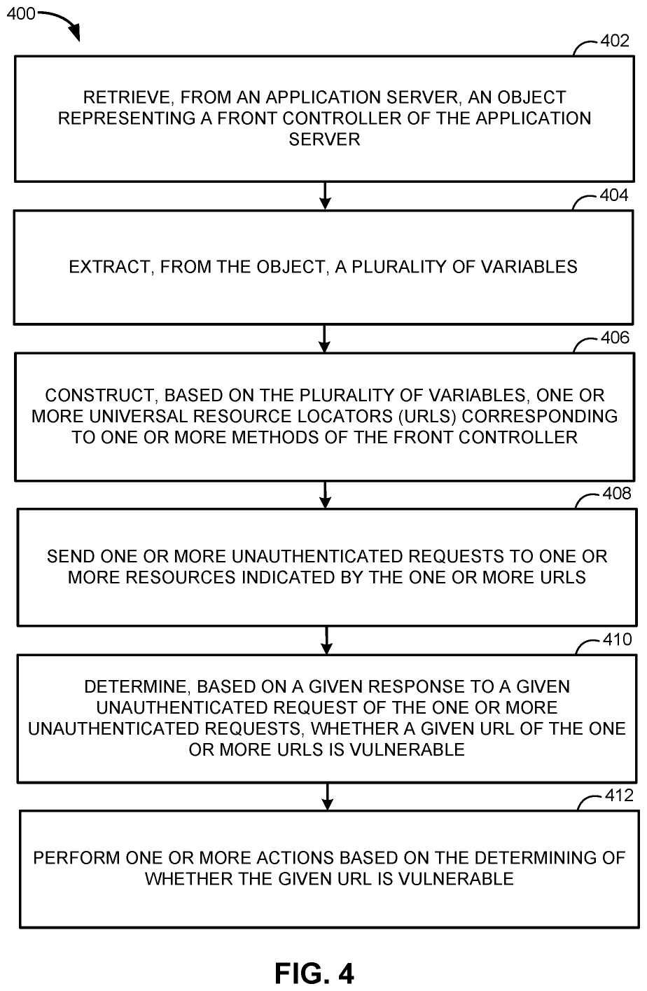

FIG. 4 depicts example operations 400 related to automated discovery of vulnerable application server endpoints. For example, operations 400 may be performed by vulnerability detector 122 of FIGS. 1-3.

Operations 400 begin at step 402, with retrieving, from an application server, an object representing a front controller of the application server. In some embodiments, retrieving, from the application server, the object representing the front controller of the application server comprises a reflection operation.

The object may comprise data of a class representing the front controller. In certain embodiments, the front controller generates the object as part of a server initialization process by storing values for the plurality of variables in an in-memory data structure

Operations 400 continue at step 404, with extracting, from the object, values for a plurality of variables.

Operations 400 continue at step 406, with constructing, based on the values for the plurality of variables, one or more universal resource locators (URLs) corresponding to one or more methods of the front controller.

Operations 400 continue at step 408, with sending one or more unauthenticated requests to one or more resources indicated by the one or more URLs. The one or more unauthenticated requests may comprise, for example, one or more of: an upload request; or a download request.

Operations 400 continue at step 410, with determining, based on a given response to a given unauthenticated request of the one or more unauthenticated requests, whether a given URL of the one or more URLs is vulnerable.

In some embodiments, determining, based on the given response to the given unauthenticated request of the one or more unauthenticated requests, whether the given URL of the one or more URLs is vulnerable comprises determining whether the given response comprises a response code other than an unauthenticated code or a forbidden code.

Operations 400 continue at step 412, with performing one or more actions based on the determining of whether the given URL is vulnerable.

In some embodiments, performing the one or more actions based on the determining of whether the given URL is vulnerable comprises one or more of: generating a notification; or crashing the application server.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and/or the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system—level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method of discovering vulnerable application server endpoints, comprising:
retrieving, from an application server, an object representing a front controller of the application server;
extracting, from the object, values for a plurality of variables;
constructing, based on the values for the plurality of variables, one or more universal resource locators (URLs) corresponding to one or more methods of the front controller;
sending one or more unauthenticated requests to one or more resources indicated by the one or more URLs;
determining, based on a given response to a given unauthenticated request of the one or more unauthenticated requests, whether a given URL of the one or more URLs is vulnerable; and
performing one or more actions based on the determining of whether the given URL is vulnerable.

2. The method of claim 1, wherein performing the one or more actions based on the determining of whether the given URL is vulnerable comprises one or more of:
generating a notification; or
crashing the application server.

3. The method of claim 1, wherein retrieving, from the application server, the object representing the front controller of the application server comprises a reflection operation.

4. The method of claim 3, wherein the object comprises data of a class representing the front controller.

5. The method of claim 1, wherein the front controller generates the object as part of a server initialization process by storing the values for the plurality of variables in an in-memory data structure.

6. The method of claim 1, wherein determining, based on the given response to the given unauthenticated request of the one or more unauthenticated requests, whether the given URL of the one or more URLs is vulnerable comprises determining whether the given response comprises a response code other than an unauthenticated code or a forbidden code.

7. The method of claim 6, wherein the one or more unauthenticated requests comprise one or more of:
an upload request; or
a download request.

8. A system for discovering vulnerable application server endpoints, the system comprising:
at least one memory; and
at least one processor coupled to the at least one memory, the at least one processor and the at least one memory configured to:
retrieve, from an application server, an object representing a front controller of the application server;
extract, from the object, values for a plurality of variables;
construct, based on the values for the plurality of variables, one or more universal resource locators (URLs) corresponding to one or more methods of the front controller;
send one or more unauthenticated requests to one or more resources indicated by the one or more URLs;
determine, based on a given response to a given unauthenticated request of the one or more unauthenticated requests, whether a given URL of the one or more URLs is vulnerable; and
perform one or more actions based on the determining of whether the given URL is vulnerable.

9. The system of claim 8, wherein performing the one or more actions based on the determining of whether the given URL is vulnerable comprises one or more of:
generating a notification; or
crashing the application server.

10. The system of claim 8, wherein retrieving, from the application server, the object representing the front controller of the application server comprises a reflection operation.

11. The system of claim 10, wherein the object comprises data of a class representing the front controller.

12. The system of claim 8, wherein the front controller generates the object as part of a server initialization process by storing the values for the plurality of variables in an in-memory data structure.

13. The system of claim 8, wherein determining, based on the given response to the given unauthenticated request of the one or more unauthenticated requests, whether the given URL of the one or more URLs is vulnerable comprises determining whether the given response comprises a response code other than an unauthenticated code or a forbidden code.

14. The system of claim 13, wherein the one or more unauthenticated requests comprise one or more of:
an upload request; or
a download request.

15. A non-transitory computer-readable medium storing instructions that, when executed by one or more processors, cause the one or more processors to:
retrieve, from an application server, an object representing a front controller of the application server;
extract, from the object, values for a plurality of variables;
construct, based on the values for the plurality of variables, one or more universal resource locators (URLs) corresponding to one or more methods of the front controller;
send one or more unauthenticated requests to one or more resources indicated by the one or more URLs;
determine, based on a given response to a given unauthenticated request of the one or more unauthenticated requests, whether a given URL of the one or more URLs is vulnerable; and
perform one or more actions based on the determining of whether the given URL is vulnerable.

16. The non-transitory computer-readable medium of claim 15, wherein performing the one or more actions based on the determining of whether the given URL is vulnerable comprises one or more of:
generating a notification; or
crashing the application server.

17. The non-transitory computer-readable medium of claim 15, wherein retrieving, from the application server, the object representing the front controller of the application server comprises a reflection operation.

18. The non-transitory computer-readable medium of claim 17, wherein the object comprises data of a class representing the front controller.

19. The non-transitory computer-readable medium of claim 15, wherein the front controller generates the object as part of a server initialization process by storing the values for the plurality of variables in an in-memory data structure.

20. The non-transitory computer-readable medium of claim 15, wherein determining, based on the given response to the given unauthenticated request of the one or more unauthenticated requests, whether the given URL of the one or more URLs is vulnerable comprises determining whether the given response comprises a response code other than an unauthenticated code or a forbidden code.
